(19) United States
(12) Patent Application Publication
(10) Pub. No.: US 2008/0137552 A1
(43) Pub. Date: Jun. 12, 2008

(54) APPARATUS AND METHOD OF MEASURING AND MANAGING REAL-TIME SPEECH QUALITY IN VoIP NETWORK

(76) Inventors: Hyun Woo Lee, Daejeon-city (KR); Jin Sul Kim, Daejeon-city (KR); Won Ryu, Daejeon-city (KR)

Correspondence Address: RABIN & Berdo, PC, 1101 14TH STREET, NW, SUITE 500, WASHINGTON, DC, 20005, US

(21) Appl. No.: 11/932,824

(22) Filed: Oct. 31, 2007

(30) Foreign Application Priority Data
Dec. 6, 2006 (KR) 10-2006-0123408
Aug. 7, 2007 (KR) 10-2007-0079185

(51) Int. Cl. H04L 12/26

(52) U.S. Cl. 370/252

(57) ABSTRACT

Provided are an apparatus and method of measuring and managing speech quality in a Voice over Internet Protocol (VoIP) network. According to the present invention, a call session and speech quality are processed by transmitting and receiving messages between a terminal and the apparatus so that a high-quality VoIP service, in which Quality of Service (QoS) between terminals is secured, can be provided to service subscribers and efficiency of quality management of VoIP services can be increased.

### CROSS-REFERENCE TO RELATED PATENT APPLICATION

This application claims the benefit of Korean Patent Application No. 10-2006-0123408, filed on Dec. 6, 2006, in the Korean Intellectual Property Office, the disclosure of which is incorporated herein in its entirety by reference.

### BACKGROUND OF THE INVENTION

1. Field of the Invention

The present invention relates to an apparatus and method of measuring speech quality in a Voice over Internet Protocol (VoIP) network, and more particularly, to an apparatus and method of measuring and managing real-time speech quality which can manage a call session message and a quality reporting message in order to measure and manage speech quality between two terminals of a VoIP network and a quality measuring server in real-time, wherein the call session message is transmitted/received according to set up and completion of a call session and the quality reporting message is transmitted/received according to such a call session process.

2. Description of the Related Art

The conventional method of measuring quality of a Voice over Internet Protocol (VoIP) service used up to the present has been performed according to standardization of the Real-time Transport Control Protocol (RTCP) by the International Standardization Organization (ISO), Internet Engineering Task Force (IETF). However, such a method is a standard suggested to control network components generated during or after voice calls and a process of controlling and managing transmission in real-time with a quality measuring server is not described in detail.

In addition, according to conventional researching documents, research was focused on real-time VoIP calls between two terminals. However, research on reporting and management of real-time quality measuring parameters according to setting up and completion of a call session by separately disposing a VoIP quality measuring server, in addition to two terminals, was not properly conducted.

Therefore, since an Internet Protocol (IP) based voice and image service is becoming the key of future services, a method of reporting and managing a speech quality message in real-time is required for quality maintenance and management in a VoIP network in which Quality of Service (QoS) is not secured.

### SUMMARY OF THE INVENTION

The present invention provides a method of managing speech quality between two terminals in a Voice over Internet Protocol (VoIP) network in an Internet call service which is rapidly developing due to the spread of Internet services so that an accurate measuring value for speech quality can be drawn and managed.

The present invention also provides a quality management of VoIP services by applying setting up and completion of a call session and quality reporting and management of the VoIP services to two terminals and a quality measuring server, in order to report and manage a real-time speech quality message during real-time voice service in a VoIP network.

According to an aspect of the present invention, there is provided an apparatus for measuring and managing speech quality between a transmission terminal and a reception terminal in a Voice over Internet Protocol (VoIP) network, the apparatus including: a call session management message processing unit which receives and processes a call session management message from the transmission terminal and the reception terminal, the call session management message comprising call session information defined according to a state between the transmission terminal and the reception terminal; and a quality reporting message processing unit which receives a quality reporting message from the transmission terminal and the reception terminal after a call session is set up, the quality reporting message comprising quality measuring parameters classified by management steps taking the correlation between the quality measuring parameters into account, and calculates speech quality by sessions.

According to another aspect of the present invention, there is provided a method of measuring and managing speech quality between a transmission terminal and a reception terminal in a Voice over Internet Protocol (VoIP) network, the method including: receiving and processing a call session management message from the transmission terminal and the reception terminal, the call session management message comprising call session information defined according to a state between the transmission terminal and the reception terminal; and receiving a quality reporting message from the transmission terminal and the reception terminal after a call session is set up, the quality reporting message comprising quality measuring parameters classified by management steps taking the correlation between the quality measuring parameters into account, and calculating speech quality by sessions.

According to another aspect of the present invention, there is provided a method of measuring and managing speech quality between a transmission terminal and a reception terminal in a Voice over Internet Protocol (VoIP) network, the method including: receiving a call request reporting message from the transmission terminal to the reception terminal and receiving a call request acceptance reporting message from the reception terminal to the transmission terminal; receiving an SSRC information reporting message of the transmission terminal and the reception terminal; receiving a speech quality reporting message from the transmission terminal and the reception terminal, the quality reporting message including the values of quality measuring parameters classified by management steps taking the correlation between the quality measuring parameters into account; and receiving a call session completion reporting message including a call session completion time.

The call session information may include at least one of call request information transmitted to the reception terminal from the transmission terminal, acceptance information of the reception terminal with respect to the call request, Synchronization Source (SSRC), and call clear information.

When the call session information includes session set-up failure information between the transmission terminal and the reception terminal, the apparatus may remove the transmission terminal and the reception terminal from a call waiting list.

The information on speech quality may include one way delay and round trip delay measured based on a packet transmission/reception time, numbers of packets transmitted/received, loss packets, and duplicated packets, and jitter, or packet loss rate, packet discard rate, R factor and E-model, and mean opinion score (MOS).

According to another aspect of the present invention, there is provided a computer readable recording medium having embodied thereon a computer program for executing the method described above.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a schematic structure of a system for measuring and managing quality of a Voice over Internet Protocol (VoIP) service and a data path according to an embodiment of the present invention;

FIG. 2 is a flowchart of a call session management message and a quality reporting message according to an embodiment of the present invention;

FIG. 3 illustrates a call session management message [Msg.Type=1, call request message form] according to an embodiment of the present invention;

FIG. 4 illustrates a call session management message [Msg.Type=2, call request message form] according to an embodiment of the present invention;

FIG. 5 illustrates a call session management message [Msg.Type=3, call request response message form] according to an embodiment of the present invention;

FIG. 6 illustrates a call session management message [Msg.Type=4, session generating message form] according to an embodiment of the present invention;

FIG. 7 illustrates a call session management message [Msg.Type=5, session completion message form] according to an embodiment of the present invention;

FIG. 8 illustrates a call session management message [Msg.Type=6, acknowledgement (ACK) message form] according to an embodiment of the present invention;

FIG. 9 illustrates a call session management message [Msg.Type=7, call set-up failure message form] according to an embodiment of the present invention;

FIG. 10 illustrates a basic header of a quality reporting message according to an embodiment of the present invention;

FIG. 11 illustrates a quality reporting message [BT=1; delay information reporting message form] according to an embodiment of the present invention;

FIG. 12 illustrates a quality reporting message [BT=2; packet loss and jitter information reporting message form] according to an embodiment of the present invention;

FIG. 13 illustrates a quality reporting message [BT=3; information reporting message form such as packet loss rate, a Mean Opinion Score (MOS), and an Overall Transmission Quality Rating (R)]

FIG. 14 is a block diagram schematically illustrating a quality measuring server according to an embodiment of the present invention;

FIG. 15 illustrates a result of measuring transmission/reception quality by call session of a quality measuring server according to an embodiment of the present invention; and

FIG. 16 is a flowchart of a method of measuring and managing speech quality in a quality measuring server according to an embodiment of the present invention.

### DETAILED DESCRIPTION OF THE INVENTION

Hereinafter, the present invention will be described more fully with reference to the accompanying drawings, in which exemplary embodiments of the invention are shown. Like reference numerals in the drawings denote like elements.

In addition, when a certain part “includes” a certain element, it is understand that other elements can further added, instead of excluding other elements, as long as there is no specific opposition.

Moreover, the term ‘module’ illustrated in this specification indicates a unit which processes a specific function or operation and can be embodied by hardware, software, or a combination thereof.

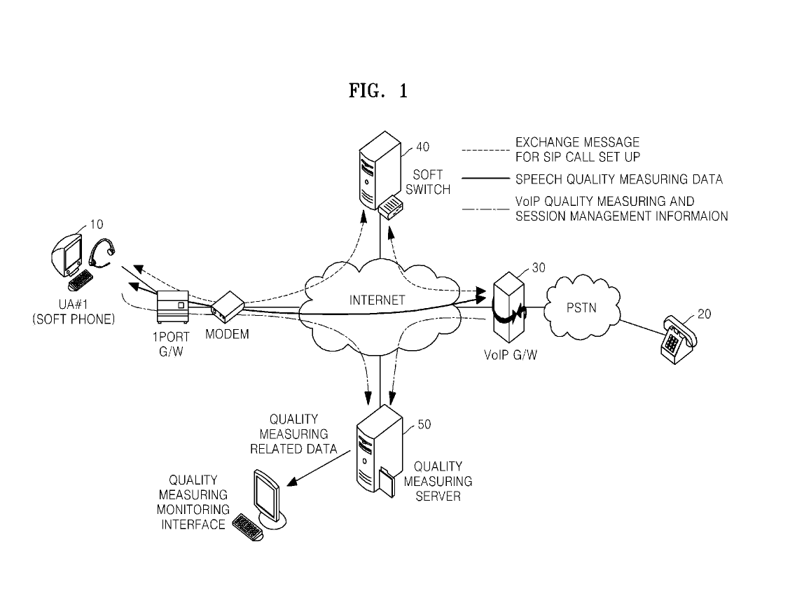

FIG. 1 is a diagram illustrating a schematic structure of a system for measuring and managing quality of a Voice over Internet Protocol (VoIP) service and a data path according to an embodiment of the present invention.

Referring to FIG. 1, the system for measuring and managing quality of the VoIP service includes terminals, a soft switch 40 for voice calls between the terminals, and a quality measuring server 50.

The terminals include a soft phone 10 by which internet phone calls are available and a pubic telephone 20, wherein the soft phone 10 uses a 1 port gateway and a modem for phone calls and the pubic telephone 20 uses a VoIP gateway (VoIP G/W) for phone calls. Each terminal collects information on a call session state between opponent terminals and a variety of data required to measure speech quality and periodically reports to the quality measuring server 50.

Each terminal transmits/receives a call session management message using a user datagram protocol (UDP) and transmits the collected quality measuring data to the quality measuring server by the quality reporting message using a real time transport protocol (RTCP).

The quality measuring server 50 receives information on a call session state and quality measuring parameters from each terminal to measure and manage speech quality between the terminals. The quality measuring server 50 processes received quality measuring data and provides quality-related indexes of the corresponding session such as an Overall Transmission Quality Rating (R) and Mean Opinion Score (MOS) to an administrator. Also, the quality measuring server 50 requires an additional protocol for managing a session such as setting up and completion of a call session between the terminals. This is because the quality measuring server should recognize the situation that a session between the terminals is set-up and completed in order to manage quality for the call session.

In the present invention, since time synchronization between two terminals is needed to accurately measure quality management parameters such as delay in real-time, a Network Time Protocol (NTP) is used.

The method of measuring and managing real-time speech quality according to the present invention can be classified into two main processes to measure and manage voice call quality in a VoIP network, that is, a call session managing process and a quality reporting message managing process according to setting up and completion of a call session due to call set-up and clear between the terminals (or hosts).

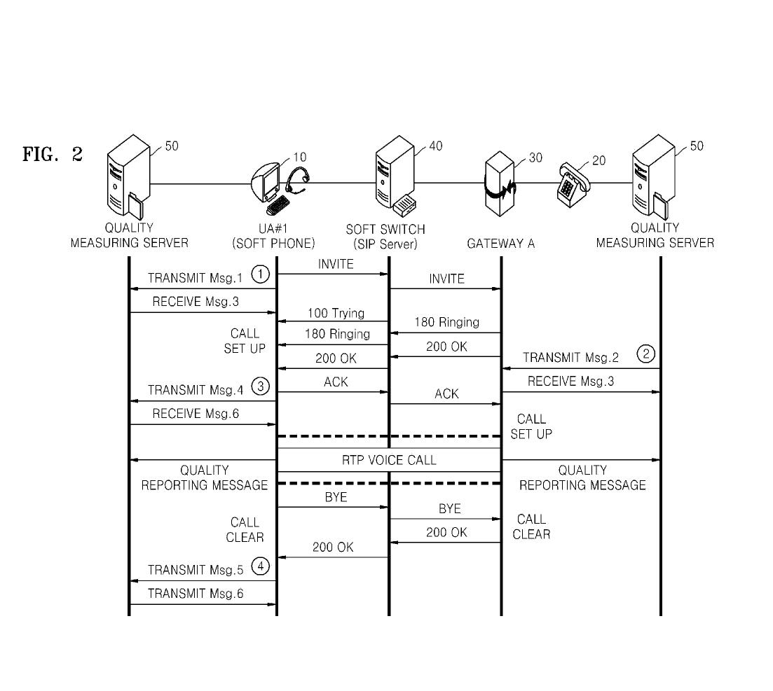

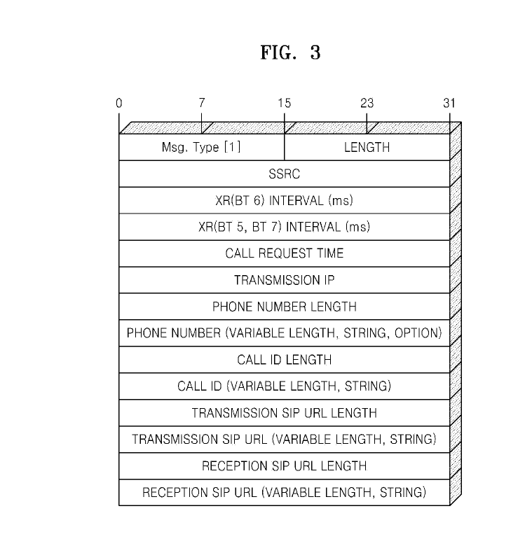

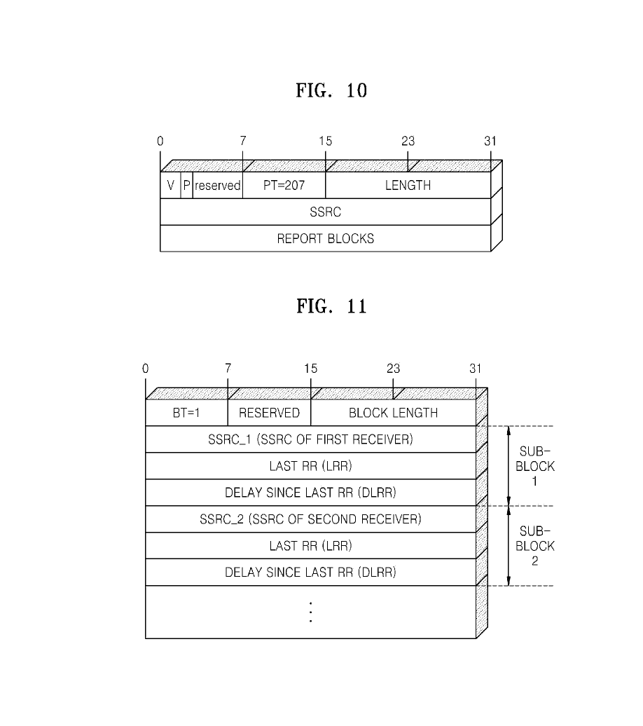

FIG. 2 is a flowchart of the call session management message and the quality reporting message according to an embodiment of the present invention. FIGS. 3 through 9 illustrate the call session management messages according to embodiments of the present invention. FIG. 10 illustrates a basic header of a quality reporting message according to an embodiment of the present invention. FIGS. 11 through 13 illustrate the quality reporting messages according to embodiments of the present invention.

The call session managing process and the speech quality measuring/managing process are classified and described with reference to FIGS. 2 through 13.

First, for the call session managing process between the quality measuring server 50 and the terminals 10 and 20 (transmission side and reception side), the quality measuring server 50 receives and processes the call session management message including call session information defined according to the state of the terminals by the transmission terminal and the reception terminal.

More specifically, in the terminals, call set-up is accomplished according to an attempt to set-up the session so that phone calls become available and then a message indicating that the session is completed due to call clear is sent to the quality measuring server 50. The terminals add session information to the message pre-defined according to the state of session set up between the terminals and the message is sent to the quality measuring server 50. Then, the quality measuring server 50 registers information about the corresponding session in the server and when the session is set up, measuring of speech quality during a real-time VoIP call is prepared.

Interworking between the terminals 10 and 20 and the quality measuring server 50 is accomplished by message forms defined as in message types 1 through 7 (FIGS. 3 through FIG. 9) using a user datagram protocol (UDP). A call connection and call clear using a Session Initiation Protocol (SIP) between the terminals are well known in the field of the present invention and thus a detailed description thereof will be omitted here.

After the transmission terminal sends a call request message to the soft switch 40 and before a call is set up, the transmission terminal transmits a call session management message type 1 (hereinafter, referred to as ‘message 1’) (FIG. 3) to the quality measuring server 50. The message 1 indicates that the transmission terminal requests a call to the reception terminal and includes a call request time, a transmission IP, a reception SIP Uniform Resource Locator (URL), and a Transmission Synchronization Source (SSRC).

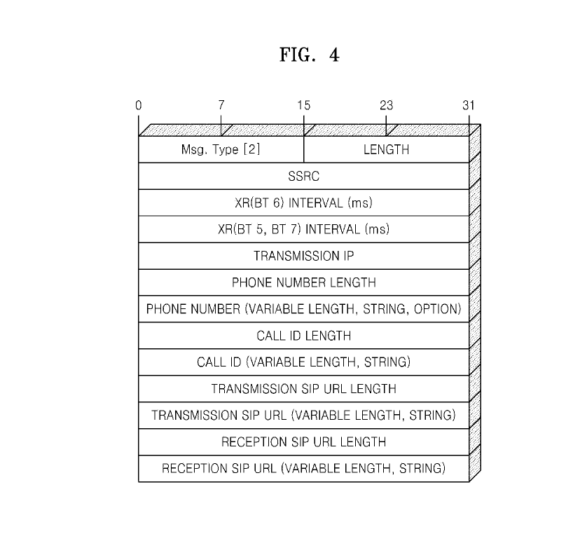

In the reception terminal which receives the call request through the soft switch 40, a call is set-up by the SIP and a call session management message type 2 (hereinafter, referred to as ‘message 2’) (FIG. 4) is transmitted to the quality measuring server 50 as a Real-time Transport Protocol (RTP) voice call is started. The message 2 indicates that the reception terminal accepts the call request made by the transmission terminal and the call is set up.

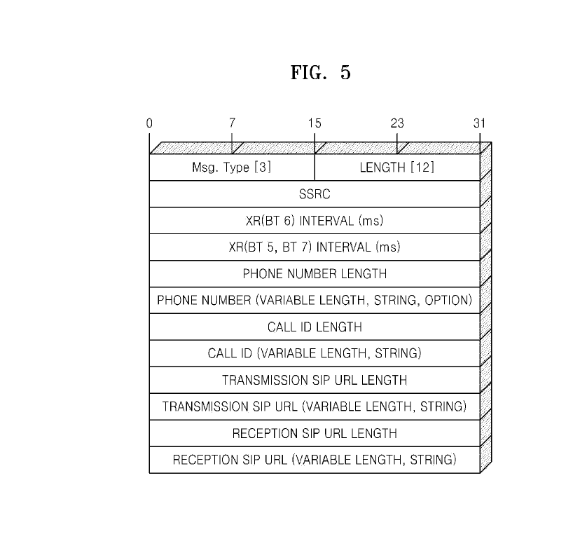

The quality measuring server 50 receives the message 1 and the message 2 from the transmission and reception terminals, respectively and analyzes the received messages to determine whether data is normal. When the data is normal, the quality measuring server 50 transmits a call session management message type 3 (hereinafter, referred to as ‘message 3’) (FIG. 5) to each terminal in response to the message 1 and the message 2. Accordingly, a session between the terminals is set.

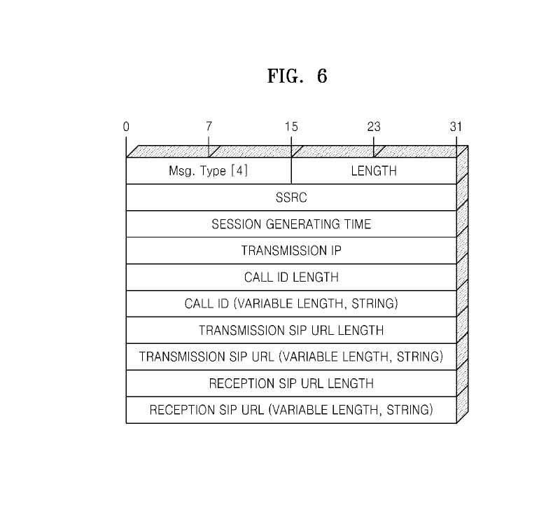

In the transmission terminal, call set-up is accomplished by the SIP of the soft switch 40 and a call session management message type 4 (hereinafter, referred to as ‘message 4’) (FIG. 6) is transmitted to the quality measuring server 50 before the RTP voice call is started. The message 4 is a session generating message and includes information for identifying whether the terminal which sends the message 4 to the quality measuring server 50 is the same as the terminal which sends the message 1, such as the Synchronization Source (SSRC) of the transmission terminal, the session generating time, and a transmission IP.

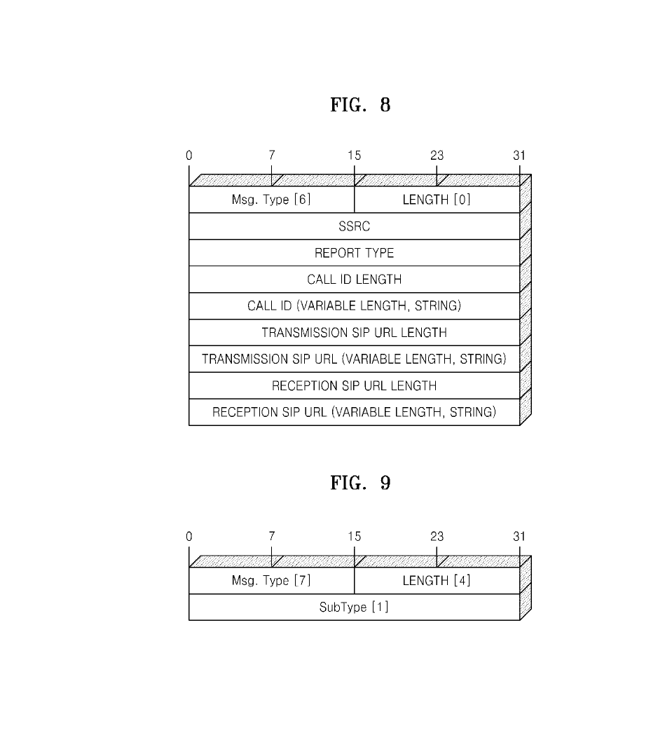

The quality measuring server 50 determines whether the message 4 received from the terminal is correct information and extracts session information to store in a database (DB). The quality measuring server 50 transmits a call session management message type 6 (hereinafter, referred to as ‘message 6’) (FIG. 8) to the terminal indicating that the corresponding message is well received. Accordingly, when the terminal receives the message 6 from the quality measuring server 50, it can be determined that the information of the terminal is registered correctly in the quality measuring server 50.

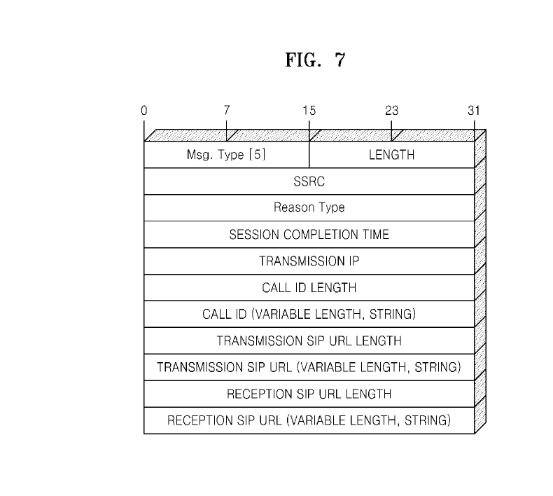

The transmission terminal transmits a call session management message type 5 (hereinafter, referred to as ‘message 5’) (FIG. 7) to the quality measuring server 50 after a call clear due to a call completion. The message 5 is a session completion message and includes the call completion time information. The quality measuring server 50 receives the message 5 from the transmission terminal and obtains the call time to store in the database (DB).

The quality measuring server 50 determines whether the message 5 received from the terminal is correct information, extracts required information, and transmits the message 6 to the terminal indicating that the corresponding message is received correctly.

The session information obtained from the received call session management message is provided later when the administrator checks quality information for the past call details.

Meanwhile, when a session is set by using the SIP of the soft switch, call set-up may not be accomplished properly so that the call set-up may be sometimes failed. When the transmission terminal requires a call to a SIP server, the transmission terminal informs the quality measuring server about the call request. However, when the call set-up by the SIP fails due to an error of the system which receives the call request, the quality measuring server 50 is informed about the failure of the call set-up so that the quality measuring server 50 can remove the corresponding terminal from the list of a call connection waiting state.

Therefore, when the call set-up fails due to the case where the opponent is on the line or refuses a call with respect to the call request or where the system has an error, the transmission terminal transmits a call session management message type 7 (hereinafter, referred to as ‘message 7’) (FIG. 9) to the quality measuring server 50. When the quality measuring server 50 receives the message 7 from the terminal, the quality measuring server 50 removes the corresponding terminal from the list of the call connection waiting state.

For convenience of description, transmission and reception of the call session management message according to setting up and completion of the session is described based on the transmission terminal. However, it is well known to one of ordinary skill in the art that the same message can be transmitted/received from the reception terminal.

When a session between the transmission terminal and the reception terminal is set, each terminal transmits the quality reporting message to the quality measuring server 50 and the quality measuring server 50 identifies the state of the terminal which transmits the message according to the type of the received quality reporting message.

Then, in a speech quality measuring/managing process of the quality measuring server 50, when a call session is set, the quality measuring server 50 receives the quality reporting message according to its type, the quality reporting message including quality measuring parameters classified by taking a correlation between the parameters into account from the transmission terminal and the reception terminal, and calculates speech quality of each session.

Since the quality reporting message according to the present invention is a RTP Control Protocol (RTCP) suggested by a standardization group of the Internet Engineering Task Force (IETF) in order to control voice quality of VoIP, in the present invention, VoIP voice quality information between two terminals can be transmitted/received in real-time based on a RTCP mechanism, in order to measure and manage real-time manual speech quality parameters.

The real-time performance measuring elements during VoIP voice calls are closely related to various quality measuring parameters such as packet loss, jitter, delay, and voice codec in a network which may affect the quality measuring.

In the present invention, a correlation between quality measuring parameters is considered in order to report and manage quality measuring and then the quality measuring parameters are classified according to their types and management steps. Then, the messages including classified parameters are transmitted so that efficient quality of service (QoS) can be expected in a VoIP network.

The quality reporting message according to the present invention can be defined into three types according to a block type.

A block type 1 (BT=1) (FIG. 11), which is the quality reporting message, is a message for reporting delay information. The terminal divides the message block for recording information on first and second packets received in order to generate delay information into a sub-block 1 and a sub-block 2 so that corresponding information can be recorded thereon.

The delay information reporting message includes information on one way delay and round trip delay. The two terminals are synchronized with each other through a Network Time Protocol (NTP) server and record the time of the moment for the RTP packet to be transmitted on a timestamp field. The terminal which receives the corresponding RTP packet measures the one way delay by considering the difference between the transmission time from the timestamp field in the RTP packet and the time at which the RTP packet is received. The round trip delay is double the one way delay.

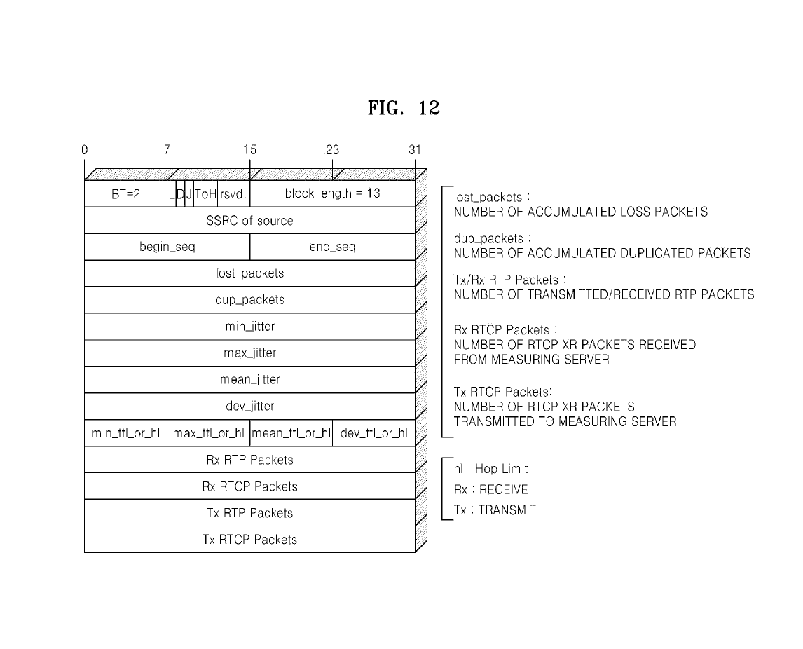

A block type 2 (BT=2) (FIG. 12), which is the quality reporting message, is a message including transmission/reception information of the RTP/RTCP packets. The terminal records information such as the numbers of the RTP/RTCP packets transmitted/received, loss packets, and duplicated packets, and jitter on the message.

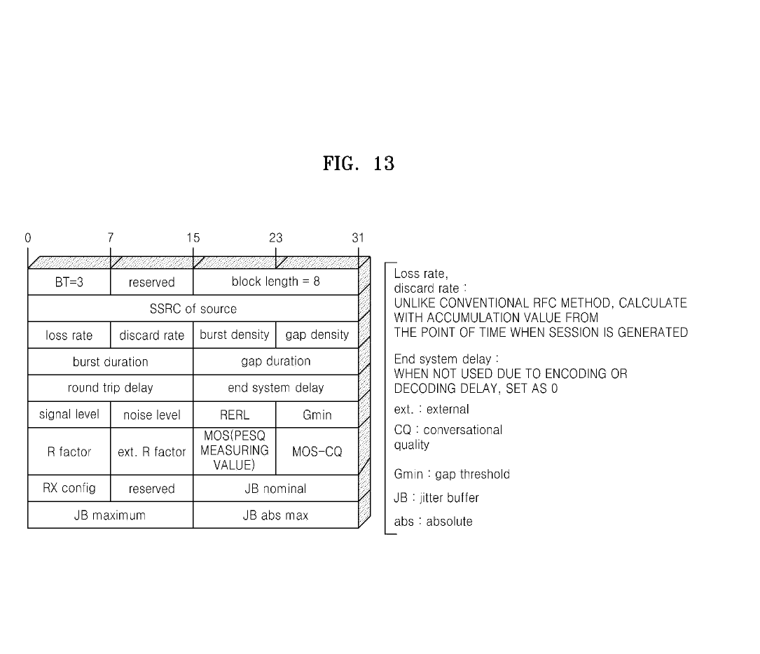

A block type 3 (BT=3) (FIG. 13), which is the quality reporting message, includes quality measuring values and quality index information such as packet loss rate, packet discard rate, burst density, burst duration, gap density, gap duration, signal level, noise level, R factor of E-model, and mean opinion score (MOS).

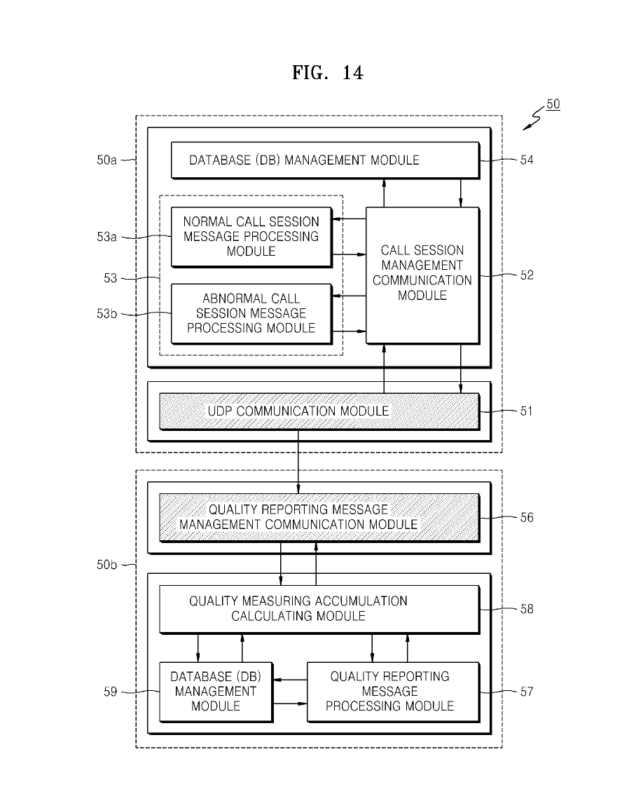

FIG. 14 is a block diagram schematically illustrating the quality measuring server according to an embodiment of the present invention.

Referring to FIG. 14, the quality measuring server 50 includes a call session management message processing unit 50a and a quality reporting message processing unit 50b.

The call session management message processing unit 50a receives the call session management message from the terminal and identifies the state of the terminal. When a session is set, the call session management message processing unit 50a provides basic information on the corresponding session to an administrator and when a session is completed due to a call completion, the call session management message processing unit 50a records call information and provides the information to the administrator.

The call session management message processing unit 50a includes a UDP communication module 51, a call session management communication module 52, a call session management message processing module 53, and a database (DB) management module 54.

The UDP communication module 51 manages a call session. The UDP communication module 51 receives the various types of call session management message according to call set-up and call clear from the terminal and determines whether the received call session management message is normal or abnormal. The UDP communication module 51 extracts session information from the call session management message.

The call session management communication module 52 receives normal or abnormal information on the call session management message and call session information from the UDP communication module 51. The call session management communication module 52 transmits normal or abnormal information on the call session management message to the call session management message processing module 53 and call session information to the DB management module 54. The call session management communication module 52 identifies set-up and completion of the session according to call session information and reports to the quality reporting message processing unit 50b through the UDP communication module 51.

The call session management message processing module 53 generates a response message with respect to the received call session management message. A normal call session message processing module 53a generates a response message with respect to the normal call session set-up and generates a control signal controlling operations according to normal session set-up and completion. An abnormal call session message processing module 53b generates a response message with respect to the abnormal call session set-up and generates a control signal controlling operations according to abnormal session set-up and completion.

The UDP communication module 51 transmits the response message generated from the call session management message processing module 53 to the corresponding terminal in a predefined call session management message form.

The DB management module 54 records call session information and log information with respect to the call session after the call session is completed/received from the call session management communication module 52 in the database and manages the recorded information.

The quality information of the terminal, that is on the line is periodically reported to the quality reporting message processing unit 50b from each terminal and is provided to the administrator in real-time. In addition, after the call is completed, the quality reporting message processing unit 50b calculates an accumulation average value with respect to speech quality and provides the value to the administrator.

The quality reporting message processing unit 50b includes a quality reporting message management communication module 56, a quality reporting message processing module 57, a quality measuring accumulation calculating module 58, and a database (DB) management module 59.

The quality reporting message management communication module 56 receives information on call session set-up and completion from the call session management message processing unit 50a. In addition, the quality reporting message management communication module 56 receives the quality reporting message including parameters required for quality measuring from the terminal and transmits the message to the quality reporting message processing module 57.

The quality reporting message processing module 57 classifies the quality reporting message received from the quality reporting message management communication module 56 by types according to management steps and extracts speech quality information so as to transmit the information to the DB management module 59. Each quality reporting message classified by types includes different speech quality information, that is, different quality measuring parameters, so that quality information distributed and reported is collected so as to be recorded on the database.

The quality measuring accumulation calculating module 58 calculates an accumulation average value of speech quality by session. When the call session is completed, the quality measuring accumulation calculating module 58 reads speech quality measuring parameters recorded with respect to the corresponding session on the DB management module 59 and calculates an accumulation value and an accumulation average value.

The quality measuring accumulation calculating module 58 records the calculated accumulation average value of speech quality data in the database as log information and allows the administrator to identify past and current information on the corresponding session at any time.

The DB management module 59 records thereon speech quality information received from the quality reporting message processing module 57, and a speech quality accumulation value and an accumulation average value calculated by the quality measuring accumulation calculating module 58.

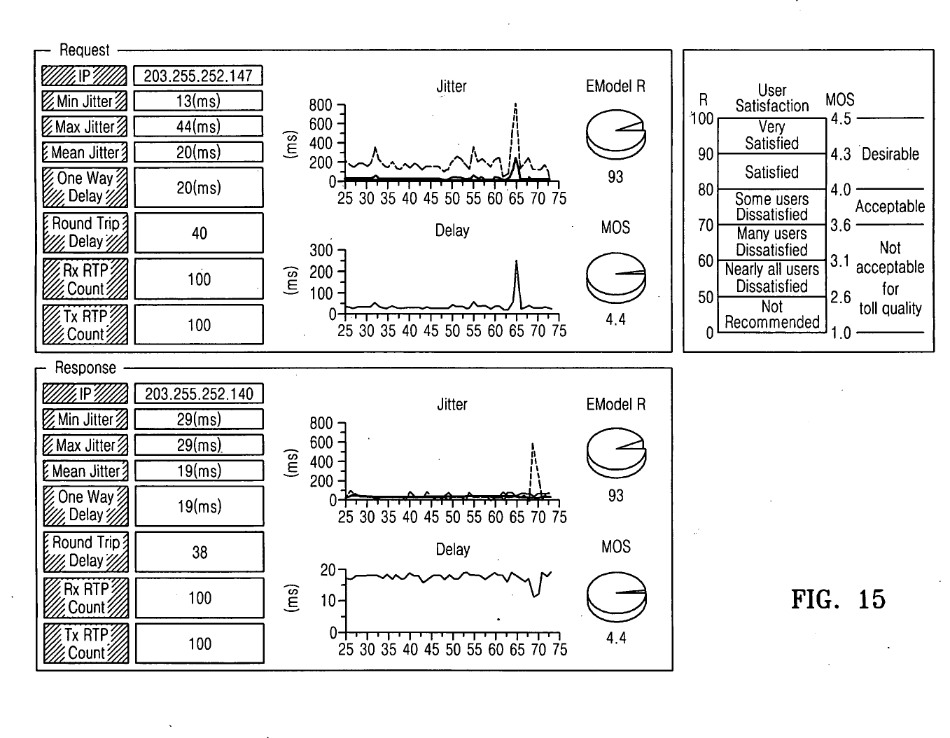

FIG. 15 illustrates a result of measuring transmission/reception quality by call session of the quality measuring server according to an embodiment of the present invention. In the embodied quality measuring monitoring function, C# is used in .NET environment so that communication between a client and a server is accomplished and a Vocal 5.0 SIP server program is applied to .NET environment.

Referring to FIG. 15, speech quality parameters in transmission/reception terminals are provided in real-time and jitter and delay are graphed to illustrate a current obstacle in an IP network according to transmission and reception of the RTP packet. The R and MOS according to the variety of speech quality parameters of the transmission/reception terminals are compared and analyzed and accurate values are provided in real-time.

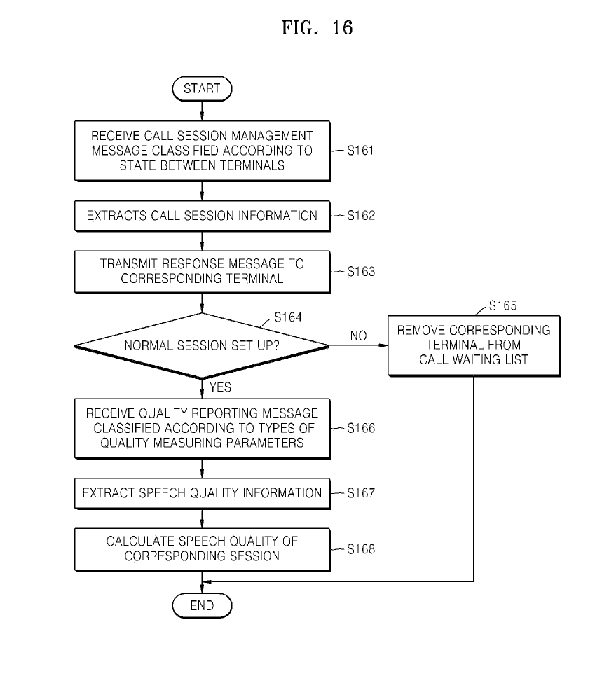

FIG. 16 is a flowchart of a method of measuring and managing speech quality in the quality measuring server according to an embodiment of the present invention. Hereinafter, the detailed description that overlaps with the above will be omitted.

Referring to FIG. 16, the quality measuring server receives the call session management message from the transmission terminal and the reception terminal in operation 161. The call session management message is a predefined message including information on call session set-up and completion according to the state between the terminals with reference to FIGS. 3 through 9.

The quality measuring server extracts call session information from the call session management message in operation 162. The extracted call session information is stored by session in the DB management module.

The quality measuring server generates a response message with respect to reception of the call session management message and transmits the response message to the corresponding terminal in operation 163.

Whether the session is normally set is determined according to the extracted call session information in operation 164. If the session set-up fails due to a system error and so on, the quality measuring server removes the corresponding terminal from a call waiting list in operation 165.

If the session is normally set, the quality measuring server receives the quality reporting message from both terminals in operation 166. The quality reporting message is classified by types of quality measuring parameters reported by the terminals according to a call state between the terminals, and the structures of the quality reporting message are illustrated in FIGS. 10 through 13.

The quality measuring server extracts speech quality information from the received quality reporting message in operation 167. The extracted speech quality information is stored by session in the DB management module.

When the completion of the session due to call clear is reported to the quality measuring server from the terminal by the call session management message, the, quality measuring server calculates speech quality of the corresponding session in operation 168. The calculated speech quality is stored by session in the DB management module and is provided to the administrator in real-time.

The invention can also be embodied as computer readable codes on a computer readable recording medium. The computer readable recording medium is any data storage device that can store data which can be thereafter read by a computer system. Examples of the computer readable recording medium, include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

In the present invention, the terminal reports the quality reporting message to the quality measuring server during call session set-up/completion between the terminals and on the line and the quality measuring server manages speech quality. When the method of measuring and managing real-time speech quality is applied to a VoIP network employing a best-effort method in which QoS is not secured, real-time speech quality can be measured and managed so that a high-quality VoIP service in which QoS between the terminals is secured can be provided to service subscribers.

In addition, since real-time quality measuring parameters according to call session set-up and completion are reported and a current speech quality state can be monitored in real-time by managing accurate quality measuring values, efficiency of quality management of the VoIP service can be increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for measuring and managing speech quality between a transmission terminal and a reception terminal in a Voice over Internet Protocol (VoIP) network, the apparatus comprising:
a call session management message processing unit which receives and processes a call session management message from the transmission terminal and the reception terminal, the call session management message comprising call session information defined according to a state between the transmission terminal and the reception terminal; and
a quality reporting message processing unit which receives a quality reporting message from the transmission terminal and the reception terminal after a call session is set up, the quality reporting message comprising quality measuring parameters classified by management steps taking the correlation between the quality measuring parameters into account, and calculates speech quality by sessions.

2. The apparatus of claim 1, wherein the call session information comprises at least one of call request information transmitted to the reception terminal from the transmission terminal, acceptance information of the reception terminal with respect to the call request, Synchronization Source (SSRC), and call clear information.

3. The apparatus of claim 1, wherein the quality measuring parameters comprise at least one of a delay time, transmission/reception packet information, a packet processing rate, and a quality index.

4. The apparatus of claim 1, wherein the call session management message processing unit comprises:
a User Datagram Protocol (UDP) communication module which classifies the received call session management message by types and extracts call session information;
a call session management message processing module which generates a response message with respect to the received call session management message based on the call session information;
a call session management communication module which transmits a state on set-up and completion of the call session according to the call session information to the quality reporting message processing unit; and
a database management module which stores therein the extracted call session information by sessions.

5. The apparatus of claim 1, wherein the quality reporting message processing unit comprises:
a quality reporting message management communication module which receives information on call session set-up and completion and the quality reporting message;
a quality reporting message processing module which classifies the received quality reporting message by types and extracts speech quality information from the quality reporting message;
a quality measuring accumulation calculating module which calculates an accumulation average value of quality measuring parameters based on the speech quality information accumulated by sessions; and
a database management module which stores therein the extracted speech quality information and the calculated accumulation average value.

6. A method of measuring and managing speech quality between a transmission terminal and a reception terminal in a Voice over Internet Protocol (VoIP) network, the method comprising:
receiving and processing a call session management message from the transmission terminal and the reception terminal, the call session management message comprising call session information defined according to a state between the transmission terminal and the reception terminal; and
receiving a quality reporting message from the transmission terminal and the reception terminal after a call session is set up, the quality reporting message comprising quality measuring parameters classified by management steps taking the correlation between the quality measuring parameters into account, and calculating speech quality by sessions.

7. The method of claim 6, wherein the call session information comprises at least one of call request information transmitted to the reception terminal from the transmission terminal, acceptance information of the reception terminal with respect to the call request, Synchronization Source (SSRC), and call clear information.

8. The method of claim 6, when the call session information comprises information on a failure of a session set-up between the transmission terminal and the reception terminal, further comprising removing the transmission terminal and the reception terminal from a call waiting list.

9. The method of claim 6, wherein the quality measuring parameters comprise at least one of a delay time, transmission/reception packet information, a packet processing rate, and a quality index.

10. The method of claim 6, wherein the receiving and processing of the call session management message comprises:
classifying the received call session management message by types and extracting call session information;
generating a response message with respect to the received call session management message based on the call session information; and
transmitting a state on set-up and completion of the call session according to the call session information to the quality reporting message processing unit.

11. The method of claim 6, wherein the calculating of the speech quality comprises:
receiving information on call session set-up and completion and the quality reporting message;
classifying the received quality reporting message by types and extracting speech quality information from the quality reporting message; and
calculating an accumulation average value of quality measuring parameters based on the speech quality information accumulated by sessions.

12. The method of claim 6,
wherein the call session management message is transmitted and received by a user datagram protocol (UDP); and
wherein the quality reporting message is transmitted and received by a real time transport protocol (RTCP).

13. A method of measuring and managing speech quality between a transmission terminal and a reception terminal in a Voice over Internet Protocol (VoIP) network, the method comprising:
receiving a call request reporting message from the transmission terminal to the reception terminal and receiving a call request acceptance reporting message from the reception terminal to the transmission terminal;
receiving an SSRC information reporting message of the transmission terminal and the reception terminal;
receiving a speech quality reporting message from the transmission terminal and the reception terminal, the quality reporting message including the values of quality measuring parameters classified by management steps taking the correlation between the quality measuring parameters into account; and
receiving a call session completion reporting message including a call session completion time.

14. The method of claim 13, further comprising calculating speech quality by sessions based on the call quality reporting message, after the call session is completed.
